(19) United States
(12) Patent Application Publication
(10) Pub. No.: US 2022/0128767 A1
(43) Pub. Date: Apr. 28, 2022

(54) WAVEGUIDE MODULE ASSEMBLIES HAVING A CLAMSHELL HOUSING

(71) Applicant: Corning Research & Development Corporation, Corning, NY (US)

(72) Inventors: Alan Frank Evans, Beaver Dams, NY (US); James Scott Sutherland, Painted Post, NY (US)

(21) Appl. No.: 17/573,022

(22) Filed: Jan. 11, 2022

Related U.S. Application Data
(63) Continuation of application No. PCT/US2020/040961, filed on Jul. 7, 2020.
(60) Provisional application No. 62/875,550, filed on Jul. 18, 2019.

(51) Int. Cl. G02B 6/36; G02B 6/38

(52) U.S. Cl. CPC G02B 6/368; G02B 6/3882

(57) ABSTRACT

Waveguide connector assemblies having a clamshell shell housing and methods of assembling a waveguide module assembly are disclosed. In one embodiment, a waveguide module assembly includes a first shell housing, and a second shell housing coupled to the first shell housing. The first shell housing and the second shell housing define a cavity. The waveguide module assembly further includes a waveguide substrate including at least one waveguide, a first surface, and a second surface opposite the first surface. The waveguide substrate is at least partially disposed within the cavity such that at least a portion of the first surface and at least a portion of the second surface are covered by at least one of the first shell housing and the second shell housing.

### CROSS-REFERENCE TO RELATED APPLICATIONS

This application is a continuation of International Application No. PCT/US2020/040961 filed Jul. 7, 2020, which claims the benefit of priority under 35 U.S.C. § 119 of U.S. Provisional Application Ser. No. 62/875,550 filed on Jul. 18, 2019, the content of which is relied upon and incorporated herein by reference in its entirety.

### BACKGROUND

### Field

The present disclosure generally relates to optical connections and, more particularly, to waveguide connector assemblies having a waveguide substrate with a plurality of waveguides.

### Technical Background

In optical communication networks, optical fibers may be routed from a junction point to a plurality of individual subscribers, such as residences, businesses, data center servers, and the like. Thus, an enclosure may be used to receive a plurality of optical fibers, and then provide optical connections to route individual optical fibers to individual subscribers. As an example, a multi-fiber connector may be provided as an input to an enclosure. A plurality of output optical connectors may also be provided at the enclosure. The output optical connectors are routed to individual subscribers. Optical paths within the enclosure route the optical signals from the multi-fiber connector to the output connectors to provide optical signals to and from the individual subscribers. Typically, the optical signals are routed within the enclosure by optical fibers. However, the management and organization of many optical fibers within the enclosure may be challenging. Further, the presence of many optical fibers may require the enclosure to be large and bulky.

### SUMMARY

In one embodiment, a waveguide module assembly includes a first shell housing, and a second shell housing coupled to the first shell housing. The first shell housing and the second shell housing define a cavity. The waveguide module assembly further includes a waveguide substrate including at least one waveguide, a first surface, and a second surface opposite the first surface. The waveguide substrate is at least partially disposed within the cavity such that at least a portion of the first surface and at least a portion of the second surface are covered by at least one of the first shell housing and the second shell housing.

In another embodiment, a waveguide module assembly for receiving optical connectors includes a first shell housing and a second shell housing coupled to the first shell housing. The first shell housing and the second shell housing define, a cavity, at least one input connector opening for receiving an input connector, and at least one output connector opening for receiving an output connector. The waveguide module assembly further includes a waveguide substrate having at least one waveguide, a first surface, and a second surface opposite the first surface. The waveguide substrate is at least partially disposed within the cavity.

In another embodiment, a waveguide module assembly for receiving optical connectors includes a first shell housing having a first cavity portion, and a second shell housing coupled to the first shell housing. The second shell housing has a second cavity portion, and the first cavity portion and the second cavity portion define a cavity when the first shell housing is mated to the second shell housing. The waveguide module assembly further includes a waveguide substrate having at least one waveguide, a first surface, and a second surface opposite the first surface. The waveguide substrate is at least partially disposed within the cavity when the first shell housing is positioned over the first surface of the waveguide substrate and the second shell housing is positioned over the second surface of the waveguide substrate.

In another embodiment, a waveguide module assembly for receiving optical connectors includes a first shell housing having a first cavity slot, and a second shell housing coupled to the first shell housing. The second shell housing has a second cavity slot, and the first cavity slot and the second cavity slot define a cavity. The waveguide module assembly further includes a waveguide substrate having at least one waveguide, a first surface, and a second surface opposite the first surface. The waveguide substrate is at least partially disposed within the cavity.

In another embodiment, a method of assembling a waveguide module assembly, includes positioning a waveguide substrate into a cavity defined by a first shell housing coupled to a second shell housing. The waveguide substrate includes at least one waveguide, a first surface and a second surface. The waveguide substrate is at least partially disposed within the cavity such that at least a portion of the first surface and at least a portion of the second surface are covered by at least one of the first shell housing and the second shell housing.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1A schematically depicts a perspective view of an example waveguide substrate according to one or more embodiments described and illustrated herein;

FIG. 1B is a top view of the example waveguide substrate shown in FIG. 1A according to one or more embodiments described and illustrated herein;

FIG. 1C schematically depicts a perspective view of another example waveguide substrate similar to FIG. 1A using a different wiring scheme according to embodiments described and illustrated herein;

FIG. 1D schematically depicts the waveguide substrate of FIG. 1C with the wiring scheme having waveguides that change positions (e.g., cross over other waveguides) according to embodiments described and illustrated herein;

FIG. 2A is an exploded, cross-section side view of a waveguide module assembly according to one or more embodiments described and illustrated herein;

FIG. 2B is a top cross-section view of the waveguide module assembly shown in FIG. 2A according to one or more embodiments described and illustrated herein;

FIG. 2C is an assembled, cross-section side view of the waveguide module assembly shown in FIGS. 2A and 2B according to one or more embodiments described and illustrated herein;

FIG. 2D is a cross-section side view of the waveguide module assembly shown in FIGS. 2A-2C, an input optical connector, and an output optical connector in an unmated state according to one or more embodiments described and illustrated herein;

FIG. 2E is a cross-section side view of the waveguide module assembly shown in FIGS. 2A-2C, an input optical connector, and an output optical connector in a mated state according to one or more embodiments described and illustrated herein;

FIG. 3 is an exploded, cross-section side view of an example waveguide module assembly having integrated alignment features according to one or more embodiments described and illustrated herein;

FIG. 4 is an exploded, cross-section side view of another example waveguide module assembly having integrated alignment features according to one or more embodiments described and illustrated herein;

FIG. 5A is an assembled, cross-section side view of an example waveguide module assembly having a clamshell housing that is laterally attached from the left and the right of the waveguide substrate according to one or more embodiments described and illustrated herein;

FIG. 5B is a cross-section top view of the waveguide module assembly depicted in FIG. 5A according to one or more embodiments described and illustrated herein;

FIG. 6 is a cross-section side view of an example waveguide module assembly having a clamshell housing that is laterally attached from the left and the right of the waveguide substrate that is mated to an input optical connector and an output optical connector according to one or more embodiments shown and described herein;

FIG. 7 is a cross-section top view of an example waveguide module assembly wherein the waveguide substrate extends beyond the edges of the clamshell housing according to one or more embodiments shown and described herein;

FIG. 8 is an exploded cross-section side view of an example waveguide module assembly having a low modulus material to allow the waveguide substrate to move within the clamshell housing according to one or more embodiments described and illustrated herein;

FIG. 9 is an exploded cross-section side view of an example waveguide module assembly having a clamshell housing with a cavity defined by tapered walls according to one or more embodiments described and illustrated herein;

FIG. 10A is an exploded cross-section side view of an example waveguide module assembly with resilient members according to one or more embodiments described and illustrated herein;

FIG. 10B is a cross-section top view of the waveguide module assembly depicted by FIG. 10A according to one or more embodiments described and illustrated herein;

FIG. 11 is a cross-section top view of an example waveguide module assembly with resilient members on proximate an input edge and non-connector edges of the waveguide substrate according to one or more embodiments described and illustrated herein;

FIG. 12 is a cross-section top view of an example waveguide module assembly having a clamshell housing that is laterally attached from the left and the right of the waveguide substrate with vertical resilient members that is mated to an input optical connector and an output optical connector according to one or more embodiments described and illustrated herein;

FIG. 13A is a cross-section side view of an example waveguide module assembly with an input cover and an output cover according to one or more embodiments described and illustrated herein;

FIG. 13B is a cross-section top view of the example waveguide module assembly shown in FIG. 13A according to one or more embodiments described and illustrated herein;

FIG. 14 is a cross-section side view of an example waveguide module assembly disposed in a housing enclosure according to one or more embodiments described and illustrated herein; and

FIG. 15 is a cross-section side view of an example waveguide module assembly having a second shell housing with flange portions having additional structures according to one or more embodiments described and illustrated herein.

### DETAILED DESCRIPTION

Embodiments described herein are directed to waveguide substrate connector assemblies that route optical signals by a plurality of waveguides within the waveguide substrate. Optical communication networks are used to provide data to a plurality of subscribers. Optical fibers are thus routed to individual subscribers, such as businesses, residences, data center servers, and the like. In some cases, optical fibers of a multi-fiber optical cable are individually routed to individual subscribers. For instance, it may be desirable to break-out traffic from a multifiber optical cable into smaller subsets of one or more optical fibers for routing the optical signals toward the desired location in the optical network. Thus, space-efficient means for routing optical signals of a multi-fiber optical connector between different, individual locations (e.g., individual subscribers) are desired. For example, individual optical fibers optically coupled to one or more multi-fiber optical connectors may be routed within a communication enclosure, and then routed to individual destinations from the enclosure. However, fiber-management of the many optical fibers within the enclosure may become unwieldy, and may require a large enclosure.

Embodiments of the present disclosure are directed to waveguide connector assemblies that include a waveguide substrate having waveguides that may replace the optical fibers within the enclosure, thereby reducing the size and cost of the enclosure. As a non-limiting example, the embodiments of the present disclosure enable the use of existing connectors while interfacing with a waveguide substrate having written waveguides within an enclosure. The module may serve as an exit point for a subscriber drop, with some optical signals “passing through,” or the enclosure may serve as a shuffle, reorienting and redirecting waveguides into new arrangements, or for wavelength division multiplexing, etc. It should be understood that other uses for the waveguide substrates described herein are possible.

Further, the waveguide connector assemblies described herein include a robust shell housing that surrounds and protects the waveguide substrate within a cavity. The concepts disclosed herein may be used with waveguide substrates having any suitable wiring scheme. The concepts of waveguide substrates may be used as a replacement for the large and bulky modules or enclosures that physically route optical fibers within a box. The concepts disclosed are advantageous since they can take less space than conventional modules or enclosures, thereby improving density. Additionally, the waveguide substrates allow adaptability for moves, adds and changes to the optical network.

As described in more detail below, embodiments provide for easy and fast assembly time and therefore an inexpensive manufacturing process. The parts are designed to snap together with the precision needed for the application. Further the waveguide connector assemblies described herein have a low cost, simplified bill of materials. A single overmolding step with coarse precision is used for connector receptacle recesses, package substrate and cover, and, in some embodiments additional alignment pins and latches. In some embodiments, no additional adhesives are needed, which prevents potential reliability issues associated with long-term creep, shrinkage and thermal degradation of the adhesive.

The waveguides within the waveguide substrates described herein may be fabricated by a laser-writing process wherein a short pulsed laser is used to create three dimensional waveguides within the material of the waveguide substrate (e.g., glass material). A short pulse (sub-picosecond) laser tightly focused into the waveguide substrate changes the material structure and locally raises the refractive index. By controlling the laser position (e.g., via translation stages), these waveguides can be created anywhere within the waveguide substrate. Further, by controlling the laser power and scan speed, single mode waveguides of low optical loss are possible.

The waveguides may extend from one edge of the waveguide substrate to another. However, waveguides at the end of the waveguide substrate may necessitate effective interconnects to transfer a signal in a waveguide into an optical fiber where it may be routed to a new destination. Embodiments of the present disclosure provide component parts and integral features for optically connecting waveguides to optical fibers within input and output optical connectors. One or more engagement and/or alignment features may be provided on edges and/or surfaces of the waveguide substrate that mate with corresponding engagement and/or alignment features of one or more optical connectors.

Alignment features on the glass sheet may include coarse alignment features and fine alignment features, both cooperating to allow a passive alignment of, for example, an LC connector and an MT-style connector to an edge of the waveguide substrate. Such coarse alignment features may include, but are not limited to, cuts in the shape of a “V” that extend from a top surface to a bottom surface of the waveguide, effectively “notching” the edge of the waveguide substrate. Corresponding features on a shell housing engage the coarse alignment features to bring engagement paths for a fiber optic connector to within axial proximity of the waveguides of the waveguide substrate. Pin bores and other features may also be fabricated on the edges of the waveguide substrate. “Float,” or rather built-in freedom of movement, allows for fine alignment as in the manner of mating two optical connectors, e.g., guide pins and split sleeves.

These alignment and/or engagement features may be fabricated into the waveguide substrates described herein by a laser-damage-and-etch process. When the laser power is increased, the material (e.g., glass) of the waveguide substrate becomes damaged such that subsequent exposure to chemical etchant causes a high selective anisotropic etching in the regions exposed to the laser. Because the etch rate of the material is higher at the regions damaged by the laser than regions not damaged by the laser, this process may be used to create alignment and/or engagement features for attaching fibers.

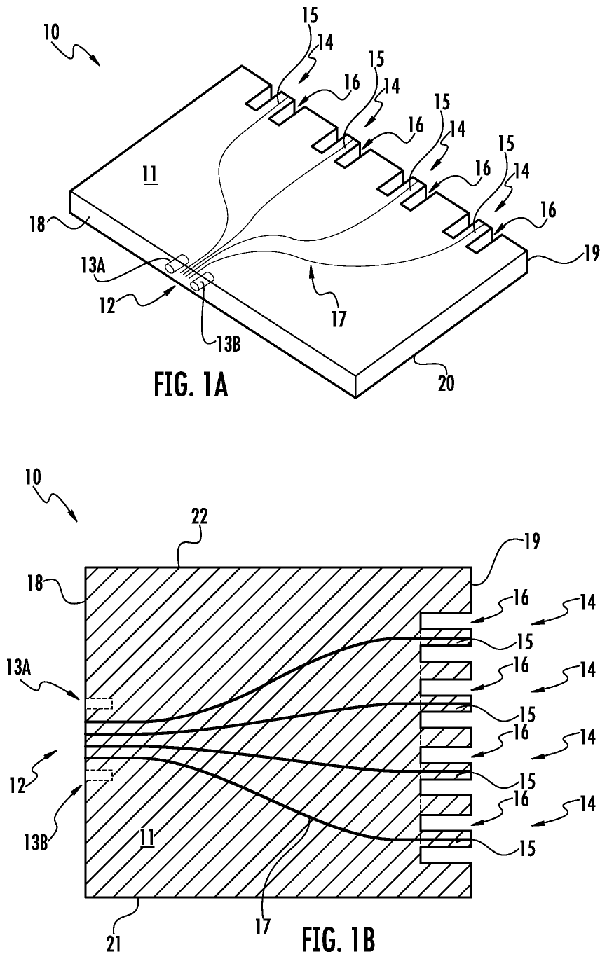

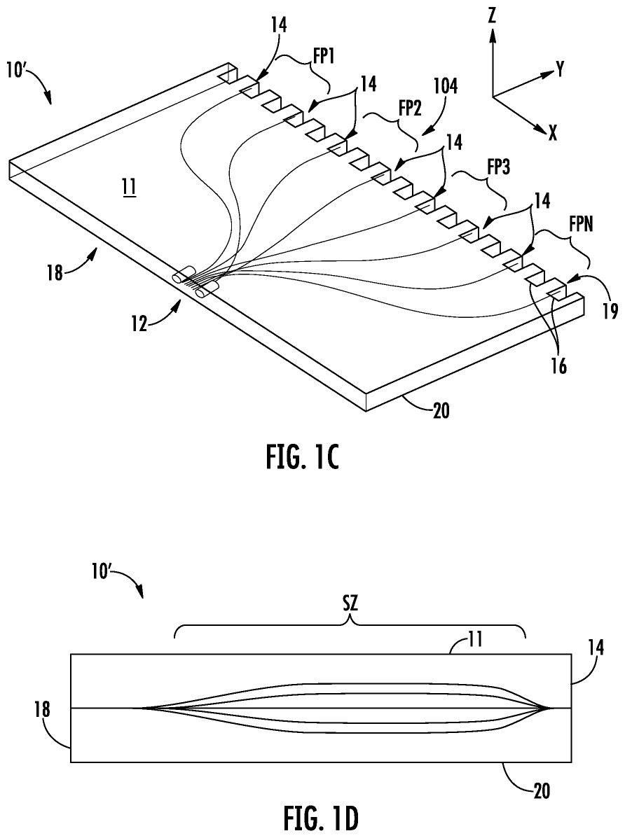

Referring now to FIGS. 1A and 1B, a non-limiting example of a waveguide substrate 10 including a plurality of waveguides 17 is schematically depicted. The waveguide substrate 10 may be fabricated from any suitable material, such as glass, sapphire and semiconductor materials such as silicon. The waveguide substrate 10 has an input edge 18, an output edge 19, a first surface 11 and a second surface 20.

As the waveguide substrate 10 routes signals of light, it may be referred to as a photonic integrated circuit (PIC).

The example waveguide substrate 10 has four waveguides 17, although it should be understood that any number of waveguides may be provided in one or multi-dimensional arrays. Each waveguide 17 is defined by a line on or within the waveguide substrate 10 having a refractive index that is different from the material outside of the waveguide 17 such that light is maintained within the waveguide 17 when propagating through the waveguide substrate 10. Any known or yet-to-be-developed methods of writing waveguides 17 into the waveguide substrate 10 may be utilized. For example, an ion-exchange process may be used to write the plurality of waveguides 17 by using a mask to change the refractive index of the material along lines defining the desired plurality of waveguides 17. As another example, a pulsed laser may be applied to apply two-dimensional or three-dimensional waveguides 17 within a bulk of the waveguide substrate 10. The waveguide index of refraction profile may be step index (i.e., uniform) or graded in the direction perpendicular to the waveguide core axis which is also the direction of light propagation.

In the illustrated example, input ends of the plurality of waveguides 17 are relatively closely spaced (i.e., have a small pitch between the waveguides) at an input 12 on the input edge 18, and branch out to be relatively largely spaced (i.e., have a large pitch as compared to the pitch at the input edge 18) at outputs 14. As a non-limiting example, and described in detail below, the input 12 may be configured to receive a MTP or MTO multiple fiber optical connector, while the outputs 14 may be configured to receive multiple SC or LC single fiber connectors. As a non-limiting example, pairs of outputs 14 may be configured to receive a duplex LC connector.

As shown in FIGS. 1A and 1B, the input edge 18 of the waveguide substrate 10 may include one or more input alignment features configured to receive alignment features of an input optical connector (not shown), such as first pin bore 13A and second input pin bore 13B disposed on opposite sides of the input 12. For example the first pin bore 13A may receive a first alignment pin of an input connector and the second pin bore 13B may receive a second alignment pin of the input connector. The size and shape of the first pin bore 13A and the second pin bore 13B are not limited by this disclosure. As a non-limiting example, the shape of a first pin bore 13A and the second pin bore 13B may be one of a slot or a circular bore.

Still referring to FIGS. 1A and 1B, each output 14 is further defined by output alignment features for receiving an output optical connector (not shown). In the illustrated embodiment, the output alignment features are defined by one or more slit openings 16 that further define a central positive feature 15, which may act as a ferrule for a fiber optic connector. As an example, 16 could be a blind hole or an annulus of removed material centered on the waveguide. Other configurations are also possible. It should be understood that embodiments are not limited to the output configuration shown in FIG. 1B. The waveguide 17 pass through and terminate at the end of the central positive feature 15. Thus, the waveguide substrate 10 may include integral ferrules for optical connection.

The input alignment features and the output alignment features may be fabricated by a laser damage and etch process. A pulsed laser beam may be applied to regions of the input edge 18 and the output edge 19 at the desired locations of the alignment features. The pulsed laser beam modifies the material of the waveguide substrate 10. The waveguide substrate 10 is then subjected to an etching solution to etch away the damaged regions to form the desired alignment features, as well as any other features. The etch rate of the damaged regions is greater than the etch rate of the material outside of the damaged regions. Therefore, the etching solution forms the desired features of the waveguide substrate 10.

It may be desirable to use the same laser used to form the plurality of waveguides 17 as the desired features, such as the alignment features. In this manner, the alignment features may be precisely registered to the plurality of waveguides 17. For example, one or more waveguides 17 may be first written into the waveguide substrate 10 by a laser. Then, the same laser may be used to damage the waveguide substrate 10 in regions corresponding with desired alignment features by referencing one or more regions of the one or more waveguides 17 as alignment reference fiducials. Similarly, the damaged regions corresponding to the alignment features may be first formed by the laser and then used as one or more reference fiducials to write the one or more waveguides.

It should be understood that the configuration of the waveguide substrates described herein may take on other configurations. For example, any number of waveguides may be provided, and embodiments are not limited to the branching out (i.e., fanning out) configuration shown in FIGS. 1A and 1B. The waveguides may be routed in any manner and terminate on one of the other edges or surfaces of the waveguide substrate 10.

By way of explanation, the waveguide substrate 10 may break-out of waveguides from a larger grouping such as 8, 12, 24, 36, 48, etc. waveguides at the input to smaller subsets such as 2, 4, 8, 12, etc. at the output. The break-out of optical signals from a large connection point to smaller connection points allows the routing of optical signals toward different locations in the optical network. For instance, breakouts may also allow for the management of transmit-receive pairs for duplex transmission or groupings of transmit and receive channels for parallel transmission applications.

FIG. 1C depicts another example waveguide substrate 10′ having eight waveguides 17 with a break-out wiring scheme. By way of explanation, there may be 8 inputs for a waveguide substrate that are grouped into 4-pairs of two outputs for duplex receive-transmit architectures; however, other pairings of receive-transmit input or outputs are possible such a 4-receive outputs and 4-transmit outputs broken-out from 8-inputs for parallel transmission architectures. Waveguide substrate 10′ of FIG. 1C comprises pairs of waveguides FP1-FPN at the output 114 that use some non-adjacent waveguides for pairing (e.g., 1-8 pair, 2-7 pair, 3-6 pair, 4-5 pair). Where the waveguides in the waveguide substrate 10′ are required to change position or cross-over other waveguides, then the waveguides may have a spaced-apart zone SZ as depicted in FIG. 1D for allowing the changing of waveguide positions without adverse cross-talk among waveguides.

Additional example configurations for waveguide substrates that may be provided in the shell housings described herein are provided in U.S. Pat. Appl. Nos. PCT/US19/25295 filed on Apr. 2, 2019 and PCT/US19/25294 filed on Apr. 2, 2019, which are hereby incorporated by reference in their entireties.

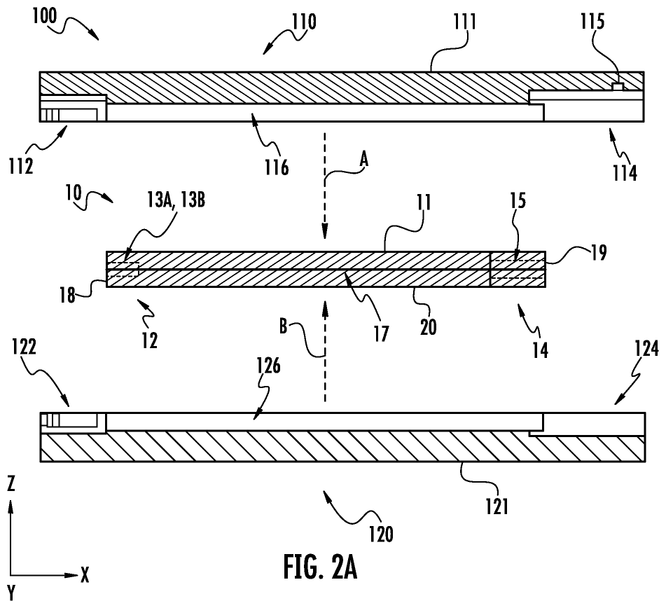

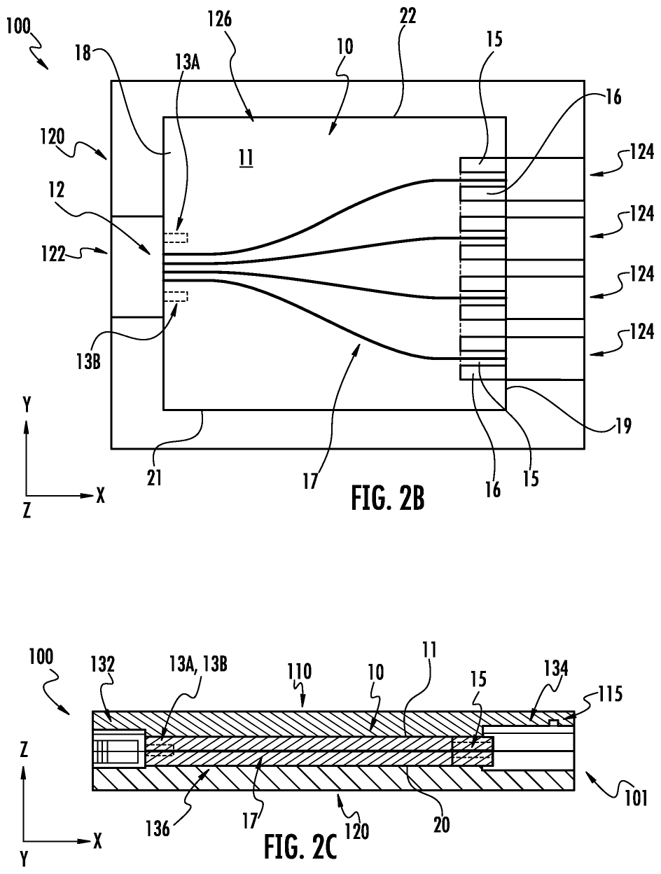

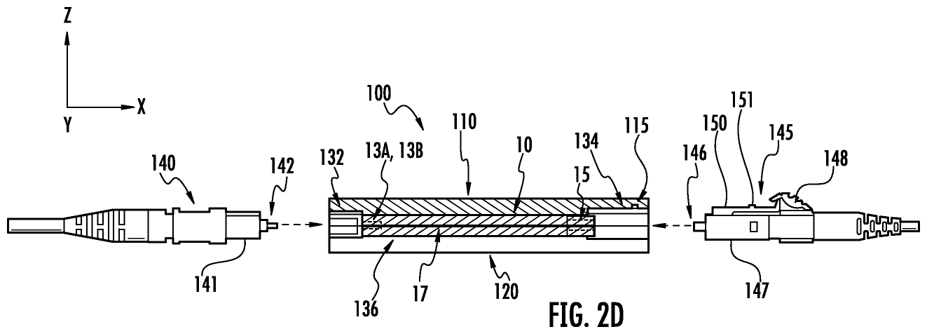

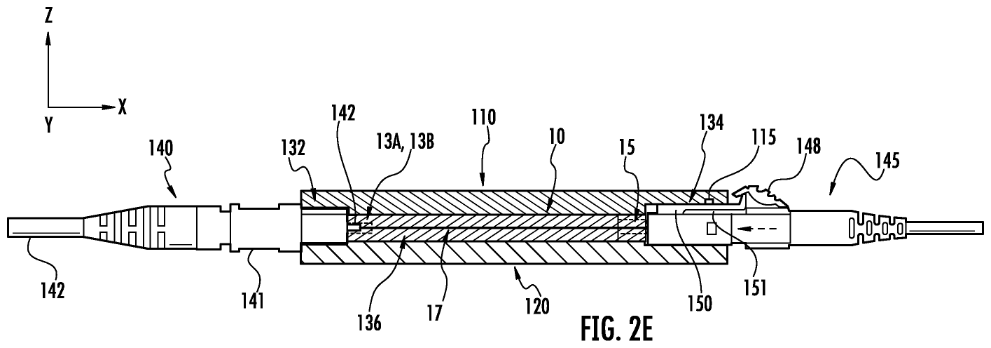

Referring now to FIGS. 2A-2C, an example waveguide module assembly 100 is illustrated. FIG. 2A is an exploded, cross-section side view of the waveguide module assembly 100, FIG. 2B is a top cross-section view of the waveguide module assembly (without showing the first shell housing 110), and FIG. 2C is an assembled, cross-section side view of the waveguide module assembly 100.

The waveguide module assembly 100 generally includes the waveguide substrate 10 and a clamshell housing 101 comprising a first shell housing 110 and a second shell housing 120. As described in more detail below, the clamshell housings described herein define a cavity in which the waveguide substrate 10 is disposed. At least a portion of the first surface 11 and the second surface 20 of the waveguide substrate are covered by first shell housing 110 and the second shell housing 120, respectively.

Referring to FIG. 2A, in the illustrated embodiment, the first shell housing 110 includes a first cavity portion 116 for receiving the waveguide substrate 10, at least one first input connector recess 112 and at least one first output connector recess 114. Similarly, the second shell housing 120 includes a second cavity portion 126, at least one second input connector recess 122, and at least one second output connector recess 124.

The first and second shell housings 110, 120 are brought together as indicated by arrows A and B such that the waveguide substrate 10 is disposed therebetween. Particularly, the first cavity portion 116 and the second cavity portion 126 cooperate to form a cavity 136 of the clamshell housing 101 where the waveguide substrate 10 is disposed (FIG. 2C). At least a portion of bottom surface 20 of the waveguide substrate 10 is covered by the second shell housing 120 and at least a portion of the top surface 11 of the waveguide substrate 10 is covered by the first shell housing 110. It should be understood that the words “top” and “bottom” are used merely for convenience and are not intended to imply any required direction or orientation.

As shown in FIGS. 2A and 2C, the at least one first input connector recess 112 and the at least one second input connector recess 122 cooperate to form at least one input connector opening 132. Although FIG. 2B illustrates only one input connector opening 132 (as shown by the second input connector recess 122 because the first shell housing 110 is not present in FIG. 2B), it should be understood that more than one input connector opening 132 may be provided.

The at least one first output connector recess 114 and the at least one second output connector recess 124 cooperate to form at least one output connector opening 134. Although FIG. 2B illustrates four output connector openings 134 (as shown by the four output connector recesses 124 because the first shell housing 110 is not present in FIG. 2B), it should be understood that any number of output connector openings 134 may be provided.

Referring now to FIGS. 2D and 2E, the input connector opening 132 is shaped and configured to receive an input optical connector 140. In the illustrated embodiment, the input optical connector 140 is a multi-fiber optical connector having a plurality of optical fibers (not shown) that are optically coupled to the plurality of waveguides 17 of the waveguide substrate 10 when the input optical connector 140 is inserted into the input connector opening 132. As used herein, the term “optically coupled” means that optical signals are capable of being passed between two optical components. The input optical connector 140 may be any suitable optical connector, such as an MTP or MPO optical connector.

Coarse alignment between the input optical connector 140 and the waveguides 17 is provided by features of the body 141 of the input optical connector 140 and features of the interior surfaces defining the input connector opening 132. Fine alignment between the optical fibers of the input optical connector 140 and the waveguides 17 is provided by insertion of the alignment pins 142 of the input optical connector 140 into the first pin bore 13A and the second pin bore 13B of the waveguide substrate 10. In other embodiments, no alignment pins or pin bores are provided. Rather, alignment is achieved by other features, such as features integrated into the body 141 of the input optical connector 140 and/or features integrated into the input connector opening 132.

The output connector opening 134 is shaped and configured to receive an output optical connector 145. In the illustrated embodiment, the output optical connector 145 is a single fiber optical connector, such as a SC optical connector, or a duplex optical connector having two connector bodies each maintaining an optical fiber (not shown), such as a LC duplex optical connector. The output optical connector 145 may be any suitable optical connector. The optical fiber within an output connector body 147 is optically coupled to an individual waveguide 17 at an output 14 of the waveguide substrate 10 (FIG. 1B). Coarse alignment between the output optical connector 145 and the output 14 of the waveguide 10 is provided by features of the body 147 of the output optical connector 145 and features of the interior surfaces of the output connector opening 134. In the illustrated embodiment, the output optical connector 145 includes a latching arm 150 having a detent feature 151 configured to mate with a notch 115 at an interior surface of the output connector opening 134, thereby securing the output optical connector 145 within the output connector opening 134. To remove the output optical connector 145 from the output connector opening 134, a user pushes down on an unlock lever 148, which causes the latching arm 150 to move toward the body 147 and the detent feature 151 to be displaced out of the notch 115 so that the output optical connector 145 may be pulled out of the output connector opening 134.

Fine alignment between the optical fiber of the output optical connector 145 and a waveguide 17 at the output 14 of the waveguide substrate 10 is provided by the interaction between the central positive feature 15 (which acts as a ferrule of the waveguide substrate 10) and a ferrule 146 of the output optical connector 145. The optical fiber (not shown) of the output optical connector 145 is disposed within the ferrule 146 and terminates at the end face of the ferrule 146. During mating the end face of the ferrule 146 of the output optical connector 145 abuts the end face of the central positive feature 15 such that the individual waveguide 17 is optically coupled to the optical fiber of the output optical connector 145. Although not shown in FIGS. 2D and 2E, a cylindrical ferrule sleeve may be disposed around the central positive feature 15 and the ferrule 146 to facilitate alignment between the waveguide 17 and the optical fiber.

The first and second shell housings 110, 120 may be made of any suitable material that will protect the waveguide substrate 10 from environmental damage or damage due to handling. As a non-limiting example, one or both of the first and second shell housings 110, 120 may be made of a transparent material, such as a transparent polymer, that allows the waveguide substrate 10 to be visually inspected for troubleshooting purposes. The transparent material described herein is transmissive to optical radiation in the visible spectrum such that the waveguide substrate is at least partially visible to an observer.

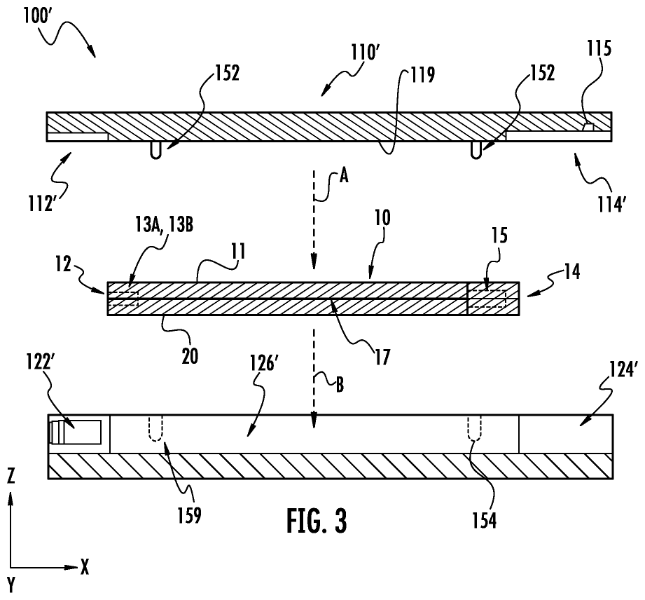

The first shell housing 110 may be secured to the second shell housing 120 by a variety of means. As an example, the first shell housing 110 may be permanently secured to the second shell housing 120, such as by an adhesive. In other embodiments, the first shell housing 110 and the second shell housing 120 are removably secured to one another. In one non-limiting example shown in FIG. 3, the first shell housing 110′ of an example waveguide module assembly 100′ has a plurality of male alignment features configured as pins 152 that are operable to mate with a plurality of female alignment features configured as bores 154 within the second shell housing 120′. The male and female alignment features aid in securing and aligning the first and second shell housings 110′, 120′. The male and female alignment features may be distributed around the perimeter of the first and second shell housings 110′, 120′, respectively, and outside of any cavity portions. It should be understood that any number of male and female alignment features may be provided. Additionally, the male and female alignment features may be configured as features other than a pin and bore, and may take on other shapes, such as a tab and slot, for example. Further, each of the first and second shell housings 110′, 120′ may include both a male alignment feature and a female alignment feature.

In the embodiment illustrated by FIG. 3, only second cavity portion 126′ of the second shell housing 120′ contributes to the volume of the cavity. The first shell housing 110′ does not include a cavity portion but rather has a planar bottom surface 119. It should be understood that this cavity arrangement may be utilized in other embodiments described herein (e.g., the embodiment shown in FIGS. 2A-2E wherein there are no male and female engagement features).

In the embodiment of FIG. 3, the second input connector recess 122′ contributes more volume to the input connector opening than the first input connector recess 112′ and the second output connector recess 124′ contributes more volume to the one or more output connector opens than the second output connector recess 114′ due to the lack of a first cavity portion within the first shell housing 110′.

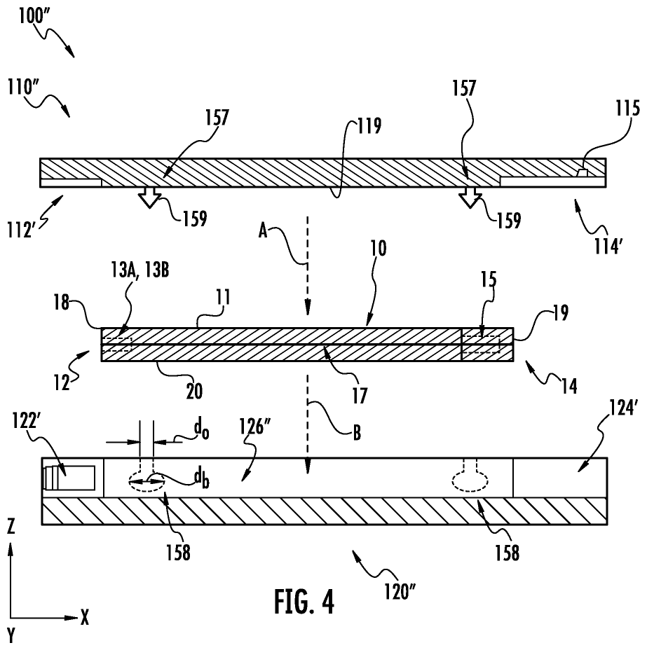

FIG. 4 illustrates an embodiment with a snap-together coupling arrangement. The waveguide module assembly 100″ includes a first shell housing 110″ has male alignment features configured as pins 157 with tabs 159 extending from a distal end in a direction back toward a bottom surface 119 of the first connector assembly 110″. The tabs 159 are compliant and may flex inward toward the body of the pin 157 when compressed.

The second shell housing 120″ includes female alignment features configured as bores 158 wherein a lower, base diameter d_{b} is larger than an opening diameter dₒ such that the tabs 159 are compressed inwards upon insertion of the pins 157 into the opening of the bores 158 until the tabs 159 reach the larger diameter base, where they then spring outward allowing the first shell housing 110″ to be secured to the second shell housing 120″.

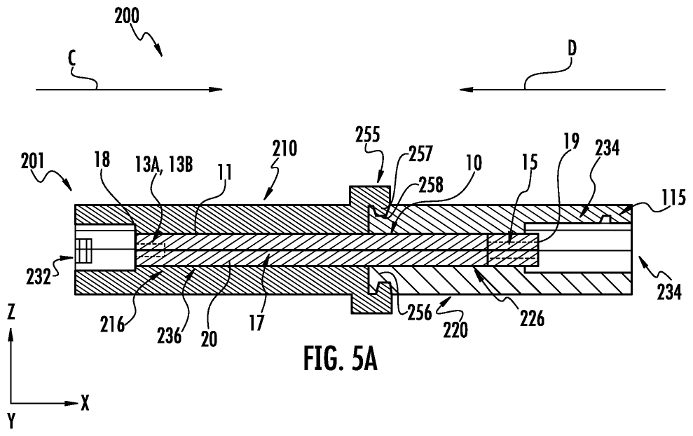

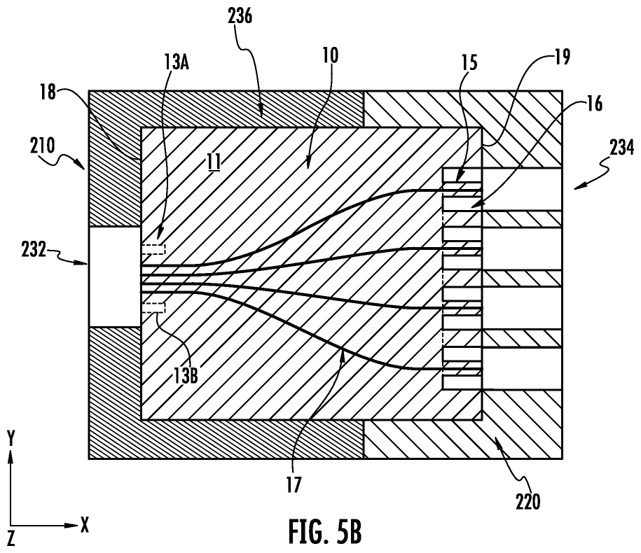

Embodiments described herein may have a clamshell housing that attached from the left and right rather from top to bottom as illustrated in FIGS. 2A-2E, 3 and 4. FIGS. 5A and 5B depict cross-section views of a waveguide module assembly 200 having a clamshell housing 201 with a first shell housing 210 and a second shell housing 220 that attach to one another from the left and right with respect to the waveguide substrate 10 (i.e., toward the input edge 18 and the output edge 19 of the waveguide substrate 10, respectively) rather from the top and bottom as indicated by arrows C and D.

As shown in FIGS. 5A and 5B, the first shell housing 210 and the second shell housing 220 each cover at least a portion of both the top surface 11 and the bottom surface 20 of the waveguide substrate 10. The first shell housing 210 has a first cavity slot 216 and the second shell housing 220 has a second cavity slot 226 that define a cavity 236 where the waveguide substrate 10 is disposed.

In the illustrated example, the first shell housing 210 defines at least one input connector opening 232 for receiving at least one input optical connector, and the second shell housing 220 defines at least one output connector opening 234 for receiving at least one output optical connector. Unlike the embodiments of FIGS. 2A-2E, 3 and 4, the first shell housing 210 defines the entirety of the at least one input connector opening 232 and the second shell housing 220 defines the entirety of the at least one output connector opening 234.

The first shell housing 210 may be coupled to the second shell housing 220 by a variety of methods. In the illustrated embodiment, the first shell housing 210 has an end 255 that mates with and engages and end 256 of the second shell housing 220. The end 255 of the first shell housing 210 has an engagement feature configured as latching arms 257. The end 256 of the second shell housing 220 has grooves 258 that receive the latching arms 257. The latching arms 257 and the walls defining the grooves 258 are tapered to enable the latching arms to slide into and out of the grooves 258 so that the first shell housing 210 may be detached from the second shell housing 220. For example, when the end 255 of the first shell housing 210 contacts the end 256 of the second shell housing, the tapered surface allows for the latching arms 257 to flex outwardly until they reach the grooves 258, where then then snap back and are seated in the grooves 258.

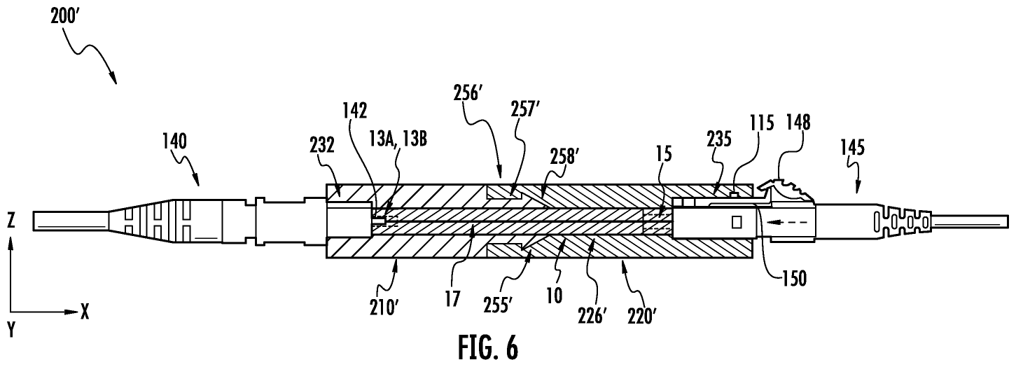

Referring now to FIG. 6, another waveguide module assembly 200′ comprising left and right attachment of first and second shell housings 210′, 220′ is illustrated. In this example, the end 255′ of the first shell housing 210′ comprises one or more prongs 257′ having an angled surface. The end 256′ of the second shell housing 220′ has tapered walls 258′ at the interior surface that defines the second cavity slot 226′. The angle of the tapered walls 258′ correspond to the angle of the angled surface of the prongs 257′. When the end 255′ of the first shell housing 210′ is inserted into the second cavity slot 226′ at the end 256′ of the second shell housing 220′, the second shell housing 220′ expands to accommodate the end 255′ of the first shell housing 210′. When the angled walls of the prongs 157′ reaches the tapered walls 258′, the second shell housing 220′ snaps back such that the prongs 257′ are seated within recesses defined by the tapered walls 258′, thereby securing the first shell housing 210′ to the second shell housing 220′.

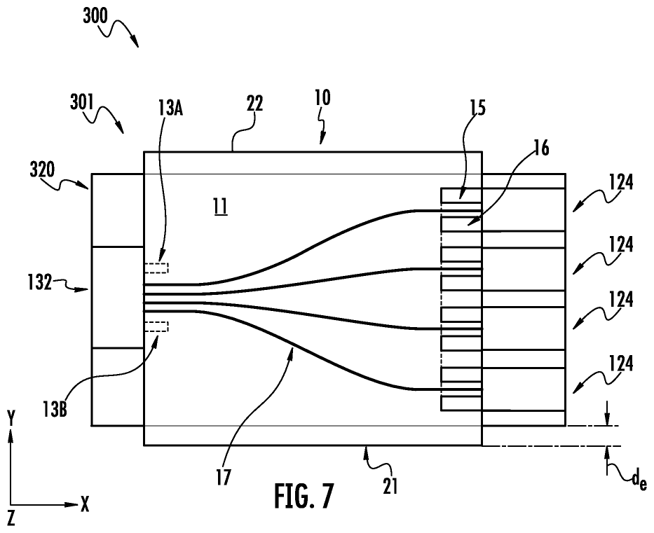

The clamshell shell housings described above completely enclose the waveguide substrate 10. However, in some embodiments, the clamshell shell housing may be designed to simply wrap around the waveguide substrate on the two connector edges (i.e., the input edge 18 and the output edge 19) leaving some side portions of the waveguide substrate exposed and uncovered. FIG. 7 illustrates an example of a waveguide module assembly 300 having a clamshell shell housing 301 (only second shell housing 320 is shown) that is a wraparound configuration that exposes side portions proximate edges 21 and 22 by an exposure distance dₑ. As an example, multiple shell housings 310 could be applied to a longer waveguide substrate at various locations.

In some embodiments, the cavity defined by the clamshell housing is larger than the waveguide substrate in at least one of the X-axis and the Y-axis to allow lateral movement of the waveguide substrate in one or two lateral directions. Freedom of the waveguide substrate to float within the clamshell housing may allow for more precise alignment of the input optical connectors and the output optical connectors with respect to the waveguide substrate because tolerance errors of the first and second shell housings and/or the bodies of the optical connectors will not contribute to misalignment. Rather, the waveguide substrate may move to be precisely positioned due to the fine alignment of the alignment pin and bores with respect to the input and the ferrule sleeves with respect to the outputs (or other fine alignment features). Additionally, the ability of the waveguide substrate to float improves force loading on the waveguide substrate due to the connection of the input optical connector and the one or more output optical connectors.

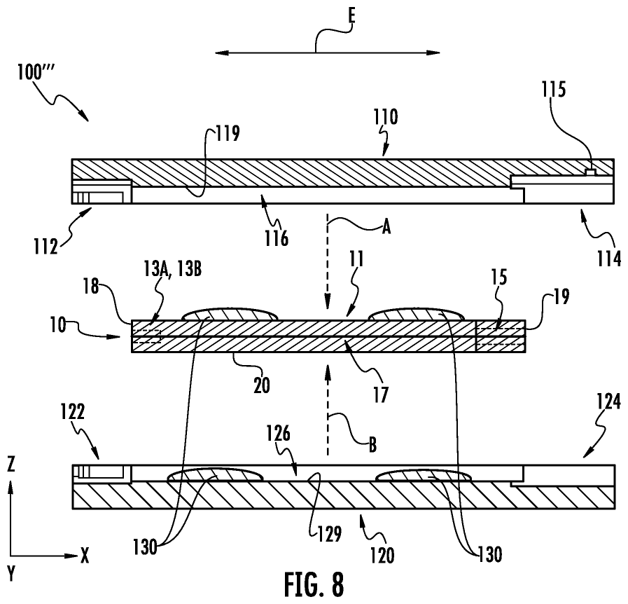

FIG. 8 illustrates a waveguide module assembly 100′″ similar to the waveguide module assembly 100 shown in FIGS. 2A-2E except that the cavity (defined by first cavity portion 116 and the second cavity portion 126) is larger than the waveguide substrate 10 in at least one of the X-axis and the Y-axis. The waveguide module assembly 100′″ further includes one or more areas 130 of low modulus material to retain the waveguide substrate 10 but also allow lateral movement. As used herein a “low modulus material” is a material having a Young's modulus of less than for example 50-80 MPa. An example low modulus material is a silicon adhesive. The low modulus material may be placed on a bottom surface 129 of the second cavity portion 126, the bottom surface 20 of the waveguide substrate 10, the top surface 11 of the waveguide substrate 10, or the bottom surface 119 of the first shell housing 110.

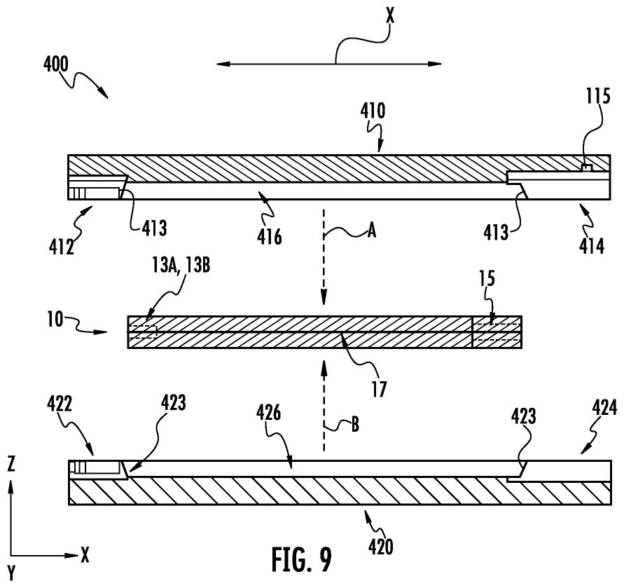

Referring to the example waveguide module assembly 400 of FIG. 9, to ease the insertion of the waveguide substrate 10 into the cavity of the clamshell shell housing, the inner sidewalls 423 of the second cavity portion 426 of the second shell housing 420 may be tapered at one or more side locations so that the second cavity portion 426 is wider at the top to simplify alignment and insertion of the waveguide substrate 10 into the second cavity portion 426. Similarly, the inner sidewalls 413 of the first shell housing 410 may be tapered at one or more side locations so that the cavity portion 416 is wider at the bottom to simplify alignment and placement of the first shell housing 410 onto the waveguide substrate 10. These tapered walls may allow some movement of the waveguide substrate 10 to float within the clamshell shell housing.

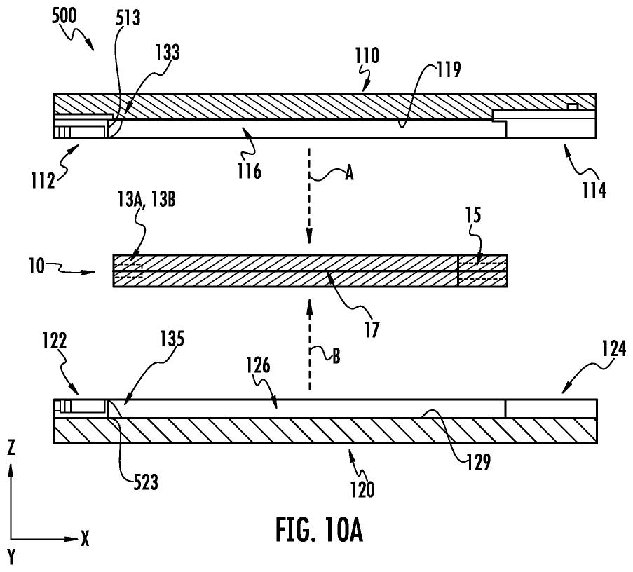

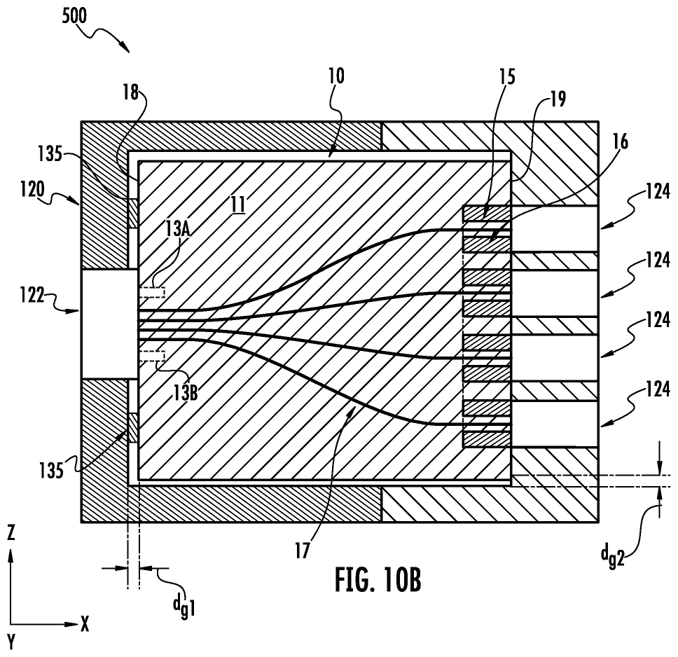

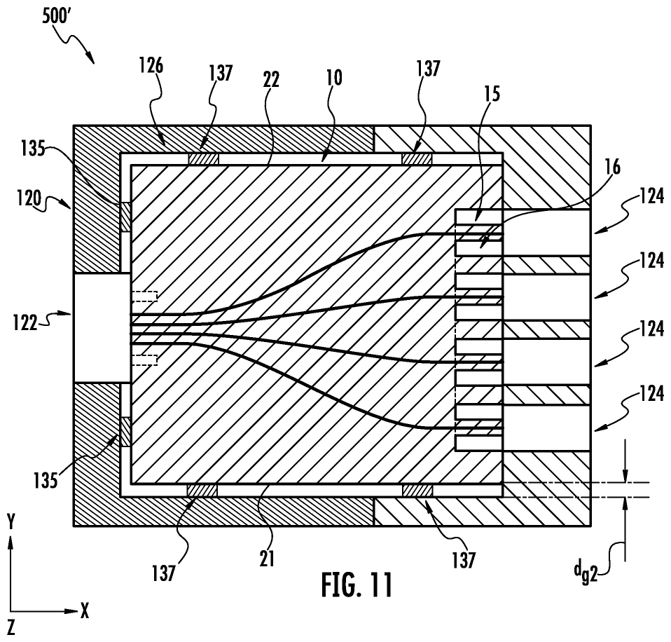

FIGS. 10A and 10B illustrate another example waveguide module assembly 500 that enables lateral movement of the waveguide substrate 10 within the clamshell shell housing. A sidewall 523 defining the second cavity portion 126 of the second shell housing 120 has one or more resilient members 135 attached thereto. The resilient members may be any resilient component capable of storing mechanical energy by deforming in response to a mechanical force and returning to an original shape when the mechanical force is removed. Example resilient members include, but are not limited to spring tabs, leaf springs, coil springs, silicone, elastomers, and the like.

FIGS. 10A and 10B illustrate the resilient members 135 as spring tabs. However, as noted above, the resilient members 135 may take on other configurations. The spring tabs 135 extend from an end of the sidewall 523 and arc in a direction toward the bottom surface 129 of the second cavity portion 126. The spring tabs 135 are made of a resilient material that may bend when the waveguide substrate 10 is inserted into the second cavity portion 126. Any number of spring tabs 135 may be provided on any number of sidewalls. Although the spring tabs 135 are shown on the sidewall 523 adjacent the second input connector recess 122, they may be located on any wall defining the second cavity portion 126.

Similarly, the first shell housing 110 may include one or more resilient members 133 attached to a sidewall 513. The resilient members 133 may be spring tabs 133 as shown in FIGS. 10A and 10B or be of a different configuration. The spring tabs 133 extend from an end of the sidewall 513 and arc in a direction toward the bottom surface 119 of the first cavity portion 116. The spring tabs 133 are made of a compliant material that may bend when the first shell housing 110 is positioned over the waveguide substrate 10 such that the waveguide substrate is disposed within the first cavity portion 116. Any number of spring tabs 133 may be provided on any number of sidewalls. Although the spring tabs 133 are shown in the sidewall 513 adjacent the first input connector recess 112, they may be located on any wall defining the first cavity portion 116.

Each of the spring tabs 133, 135 are adjacent an edge of the waveguide substrate 10 when the waveguide substrate is disposed within the cavity defined by the first shell housing 110 and the second shell housing 120. In the illustrated embodiment, the spring tabs 133, 135 are adjacent to the input edge 18 of the waveguide substrate 10.

The spring tabs 133, 135 (or other resilient members) may take up any length difference between the waveguide substrate 10 exterior and the walls of the cavity defined by the first shell housing 110 and the second shell housing 120. This prevents the glass substrate from excessive “rattle” movement inside the cavity.

Referring now to FIG. 11, an example waveguide module assembly 500′ similar to the waveguide module assembly 500 is illustrated. The waveguide module assembly 500′ has resilient members configured as spring tabs 137 located proximate non-connector edges 21, 22 to simplify lateral alignment of connectors to waveguide substrate precision alignment features (e.g., the first and second alignment bores 13A, 13B and the central positive features 15). It should be understood that the spring tabs 137 may be configured as different resilient members as described above. These spring tabs 137 may also accommodate typical variations in the width of the waveguide substrate 10 due to dicing. The spring tabs 137 may be similar to the spring tabs 133, 135 shown in FIG. 10A. It should be understood that additional spring tabs may be provided on a first shell housing (not shown in FIG. 11) in addition to the spring tabs 137 provided on the second shell housing 120 shown in FIG. 11.

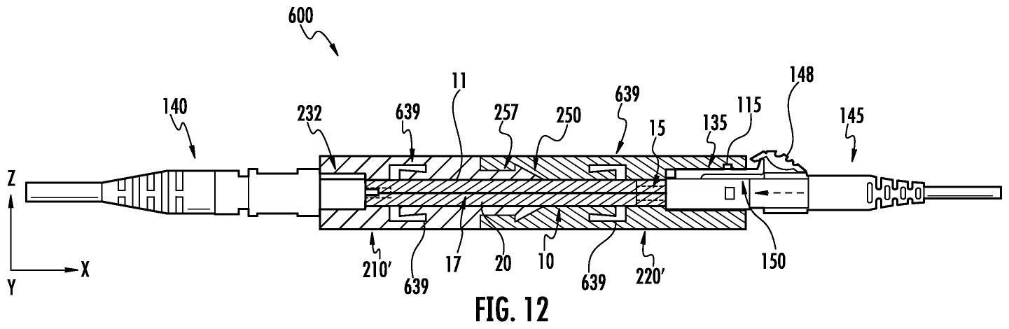

Spring tabs or other resilient members configured as biasing features may also be incorporated into the clamshell shell housing to properly bias the waveguide substrate in the vertical direction (i.e., the Z-axis direction) within the cavity, thereby accommodating variations in the thickness of the waveguide substrate. FIG. 12 illustrates an example waveguide module assembly 600 having vertical bias members configured as spring tabs 639 that are C-shaped and extend from the first shell housing 210′ and the second shell housing 220′ to both the top surface 11 and bottom surface 20 of the waveguide substrate 10. Any number of spring tabs 639 or other vertical bias members may be provided. Further, it should be understood that the spring tabs 639 may take on a shape other than the C-shape shown in FIG. 12, and vertical spring tabs can be applied to top and bottom shell housing embodiments.

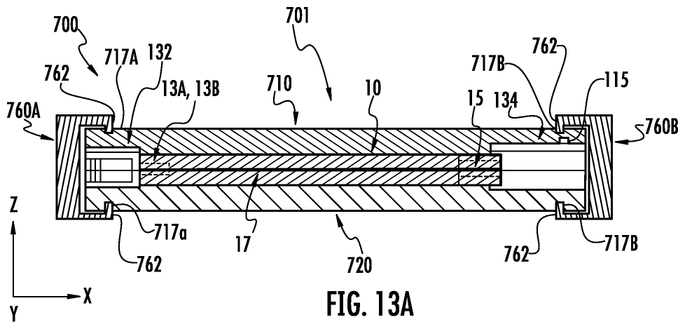

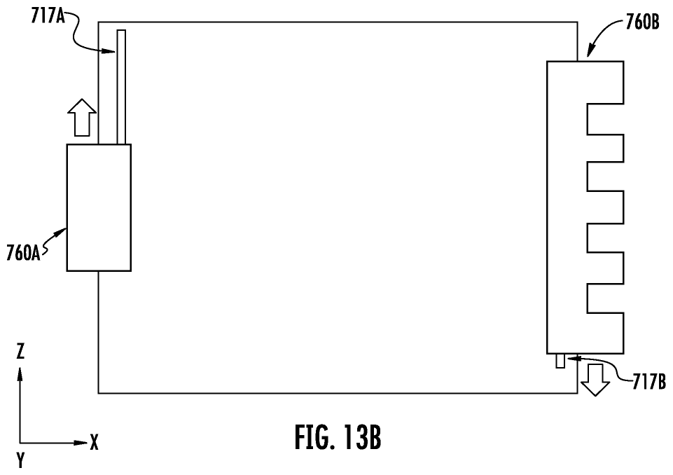

The clamshell shell housing may also include molded covers that may be easily transitioned from an open position to a closed position to protect connector openings from dust and debris. FIGS. 13A and 13B illustrate an example waveguide module assembly 700 having two covers for protecting the at least one input connector opening 132 and the at least one output connector opening 134. In the non-limiting example of FIGS. 13A and 13B, an input cover 760A is disposed on an input end of the clamshell shell housing 701. The input cover 760A of the example embodiment has a U-shape with hook portions 762 that are seated into grooves 717A in both the first shell housing 710 and the second shell housing 720. Referring to FIG. 13B, the input cover 760A is translatable from a closed position as shown in FIG. 13B, to an open position by sliding the input cover 760A along the grooves 717A in a direction indicated by arrow 51. In this embodiment, the input cover 760A completely blocks the input connector opening 132 when in the closed position. The input cover 760A is slid to provide access to the input connector opening 132.

The output cover 760B of the example embodiment also has a U-shape in cross section with hook portions 762 that are seating in grooves 717B in both the first shell housing 710. In the illustrated embodiment, the output cover 760B has apertures 763 that allow access to the output connector openings 134 so that output optical connectors may be inserted therein. FIG. 13B illustrates the output cover 760B in an open position. The output cover 760B is slid along grooves 717B in a direction indicated by arrow S2 to move the output cover 760B to a closed position, wherein material of the output cover 760B prevents access to the output connector openings 134 and prevents dust and debris from entering therein.

It should be understood that other cover embodiments are also possible. For example the cover may be on a molded arm that swings to block the connector openings.

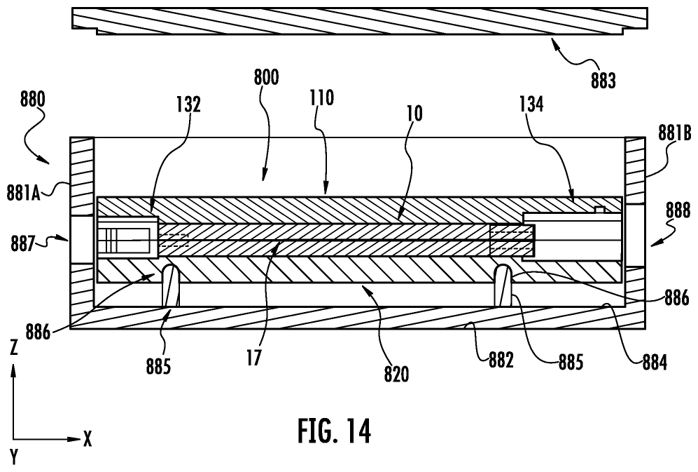

The waveguide connector assemblies described herein may also be disposed in larger enclosures depending on the application. FIG. 14 illustrates an example waveguide module assembly 800 that is disposed in an enclosure housing 880. The enclosure housing 880 has a base portion 882 with a base surface 884, and sidewalls including an input sidewall 881A and an output sidewall 881B. In the illustrated example, the enclosure housing 880 includes alignment posts 885 extending from the base surface 884 that are inserted into alignment bores 886 of the second shell housing 820 of the waveguide module assembly 800 to align the waveguide module assembly 800 to an input sidewall opening 887 (or multiple input sidewall openings) and one or more output sidewall openings 888. It should be understood that alignment features other than posts and bores may be utilized to align the waveguide module assembly 800 within the enclosure housing 880.

As shown in FIG. 14, the input sidewall opening 887 provides access to the input connector opening 132, and the output sidewall openings 888 provide access to the one or more output connector openings 134. Additionally, the enclosure housing 880 may also include a lid 883 that is attached to the sidewalls.

The enclosure housing 880 may be configured to enclose one or multiple waveguide connector assemblies 800.

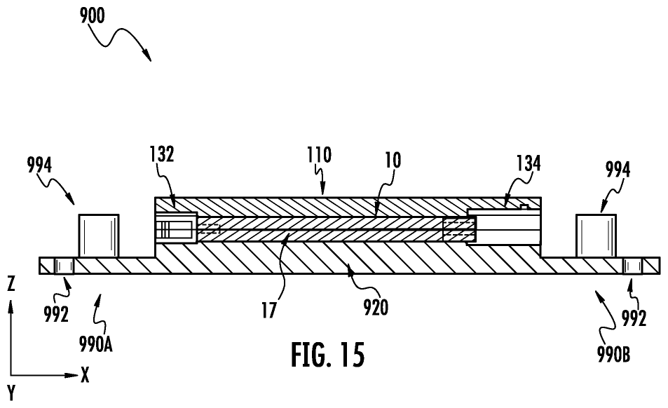

The first and/or second shell housing may include additional structures and features. Referring to FIG. 15 another example waveguide module assembly 900 is illustrated. The first shell housing 110 is similar to the embodiment depicted in FIGS. 2A-2E. However, the second shell housing 920 has additional features as compared to the second shell housing 120 depicted in FIGS. 2A-2E. The second shell housing 920 is longer in the X-direction than the first shell housing 110. The second shell housing 920 has a first flange portion 990A and a second flange portion 990B that have additional structures. Each of the first flange portion 990A and the second flange portion 990B include one or more mounting holes 992 for mounting the waveguide module assembly 900 to another substrate or enclosure housing. As an example the mounting holes 992 may be positioned according to a standardized footprint so that the waveguide module assembly 900 may be easily mounted to standardized housings or substrates. Additionally, the first flange portion 990A and the second flange portion 990B may also include one or more cable routing features 994 that assist in routing and organizing optical fibers. The upper and lower clamshell shell housing features may also be integrated into larger surrounding component enclosures.

It should now be understood that embodiments of the present disclosure are directed to waveguide connector assemblies comprising a clamshell shell housing that maintains a waveguide substrate having a plurality of waveguides. The clamshell shell housing has integrated input and output connector openings for receiving input and output connectors. The clamshell shell housing also includes internal features that align the waveguides of the waveguide substrate to the input and output connector openings.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

1. A waveguide module assembly for receiving optical connectors, the waveguide module assembly comprising:
a first shell housing;
a second shell housing coupled to the first shell housing, wherein the first shell housing and the second shell housing define a cavity; and
a waveguide substrate comprising at least one waveguide, a first surface, and a second surface opposite the first surface, wherein the waveguide substrate is at least partially disposed within the cavity such that at least a portion of the first surface and at least a portion of the second surface are covered by at least one of the first shell housing and the second shell housing.

2. The waveguide module assembly of claim 1, wherein the first shell housing is positioned about the first surface of the waveguide substrate and the second shell housing is positioned about the second surface of the waveguide substrate.

3. The waveguide module assembly of claim 2, wherein:
the first shell housing comprises a first cavity portion;
the second shell housing comprises a second cavity portion; and
the first cavity portion and the second cavity portion define the cavity when the first shell housing is mated to the second shell housing.

4. The waveguide module assembly of claim 3, wherein:
a plurality of first tapered sidewalls define the first cavity portion; and
a plurality of second tapered sidewalls define the second cavity portion.

5. The waveguide module assembly of claim 3, further comprising at least one first resilient member coupled to an interior surface defining the first cavity portion, and at least one second resilient member coupled to an interior surface defining the second cavity portion.

6. The waveguide module assembly of claim 5, wherein the at least one first resilient member and the at least one second resilient member are adjacent an edge of the waveguide substrate.

7. The waveguide module assembly of claim 6, wherein the at least one first resilient member and the at least one second resilient member are adjacent to at least one of the first surface and the second surface.

8. The waveguide module assembly of claim 2, wherein the second shell housing comprises a cavity portion that defines the cavity when the first shell housing is mated to the second shell housing.

9. The waveguide module assembly of claim 8, wherein one of the first shell housing and the second shell housing comprises at least one male alignment feature, and the other of the first shell housing and the second shell housing comprises at least one female alignment feature operable to receive the at least one male alignment feature.

10. The waveguide module assembly of claim 9, wherein the at least one male alignment feature is a pin and the at least one female alignment feature is a bore.

11. The waveguide module assembly of claim 10, wherein the pin comprises one or more tabs, and the bore comprises a base diameter that is larger than an opening diameter.

12. The waveguide module assembly of claim 2, further comprising a material disposed between the first surface of the waveguide substrate and an interior surface of the first shell housing.

13. The waveguide module assembly of claim 12, wherein at least one of a length and a width of the cavity is larger than at least one of a length and a width of the waveguide substrate.

14. The waveguide module assembly of claim 1, wherein the first shell housing and the second shell housing define at least one input connector opening for receiving an input connector, and the first shell housing and the second shell housing define at least one output connector opening for receiving an output connector.

15. The waveguide module assembly of claim 14, wherein:
the at least one waveguide comprises a plurality of waveguides;
the at least one output connector opening comprises a plurality of output connector openings;
the at least one input connector opening comprises one input connector opening; and
the plurality of waveguides branches from an input edge of the waveguide substrate at the one input connector opening to an output edge of the waveguide substrate at the plurality of output connector openings.

16. The waveguide module assembly of claim 14, wherein an interior surface at the at least one output connector opening comprises a notch for receiving a detent feature of the output connector.

17. The waveguide module assembly of claim 14, wherein:
the first shell housing comprises at least one first input connector recess and at least one first output connector recess;
the second shell housing comprises at least one second input connector recess and at least one second output connector recess;
the at least one first input connector recess and the at least one second input connector recess define the at least one input connector opening; and
the at least one first output connector recess and the at least one second output connector recess define the at least one output connector opening.

18. The waveguide module assembly of claim 14, further comprising at least one input cover positioned at an edge of the first shell housing and the second shell housing, wherein the at least one input cover is configured to translate between an open position that provides access to the at least one input connector opening and a closed position that prevents access to the at least one input connector opening.

19. The waveguide module assembly of claim 14, further comprising at least one output cover positioned at an edge of the first shell housing and the second shell housing, the at least one output cover having the at least one output connector opening, wherein the at least one output cover is configured to translate between an open position that provides access to the at least one output connector opening and a closed position that prevents access to the at least one output connector opening.

20. The waveguide module assembly of claim 1, wherein:
the first shell housing comprises a first cavity slot and the second shell housing comprises a second cavity slot; and
the first cavity slot and the second cavity slot define the cavity such that each of the first shell housing and the second shell housing covers a portion of the first surface and a portion of the second surface of the waveguide substrate.

21. The waveguide module assembly of claim 20, wherein the first shell housing has a first engagement feature at an end and the second shell housing has a second engagement feature at a second end that mates with the first engagement feature.

22. The waveguide module assembly of claim 21, wherein the first engagement feature comprises one or more latching arms and the second engagement feature comprises one or more grooves.

23. The waveguide module assembly of claim 21, wherein the first engagement feature comprises one or more prongs having an angled surface, and the second engagement feature comprises one or more tapered walls operable to receive the one or more prongs.

24. The waveguide module assembly of claim 1, wherein the first shell housing defines at least one input connector opening for receiving an input connector, and the second shell housing defines at least one output connector opening for receiving an output connector.

25. The waveguide module assembly of claim 1, wherein the waveguide substrate comprises:
an input edge and an output edge extending from the first surface to the second surface such that the at least one waveguide extends from the input edge to the output edge such that an input end of the at least one waveguide is at the input edge and an output end of the at least one waveguide is at the output edge;
at least one input alignment feature within the input edge adjacent to the input end of the at least one waveguide; and
at least one output alignment feature within the output edge adjacent to the output end of the at least one waveguide.

26. The waveguide module assembly of claim 1, wherein a width of the waveguide substrate is larger than a width of each of the first shell housing and the second shell housing.

27. The waveguide module assembly of claim 1, wherein the first shell housing and the second shell housing are made of a material that is transmissive to optical radiation in the visible spectrum.

28. The waveguide module assembly of claim 1, further comprising an enclosure housing, wherein the first shell housing, the second shell housing and the waveguide substrate are positioned within the enclosure housing.

29. A waveguide module assembly for receiving optical connectors, the waveguide module assembly comprising:
a first shell housing;
a second shell housing coupled to the first shell housing, wherein the first shell housing and the second shell housing define, a cavity, at least one input connector opening for receiving an input connector, and at least one output connector opening for receiving an output connector; and
a waveguide substrate comprising at least one waveguide, a first surface, and a second surface opposite the first surface, wherein the waveguide substrate is at least partially disposed within the cavity.

30. The waveguide module assembly of claim 29, wherein:
the at least one waveguide comprises a plurality of waveguides;
the at least one output connector opening comprises a plurality of output connector openings;
the at least one input connector opening comprises one input connector opening; and
the plurality of waveguides branches from an input edge of the waveguide substrate at the one input connector opening to an output edge of the waveguide substrate at the plurality of output connector openings.

31. The waveguide module assembly of claim 29, wherein an interior surface at the at least one output connector opening comprises a notch for receiving a detent feature of the output connector.

32. The waveguide module assembly of claim 29, wherein:
the first shell housing comprises at least one first input connector recess and at least one first output connector recess;
the second shell housing comprises at least one second input connector recess and at least one second output connector recess;
the at least one first input connector recess and the at least one second input connector recess define the at least one input connector opening; and
the at least one first output connector recess and the at least one second output connector recess define the at least one output connector opening.

33. The waveguide module assembly of claim 29, further comprising at least one input cover positioned at an edge of the first shell housing and the second shell housing, wherein the at least one input cover is configured to translate between an open position that provides access to the at least one input connector opening and a closed position that prevents access to the at least one input connector opening.

34. The waveguide module assembly of claim 29, further comprising at least one output cover positioned at an edge of the first shell housing and the second shell housing, the at least one output cover having the at least one output connector opening, wherein the at least one output cover is configured to translate between an open position that provides access to the at least one output connector opening and a closed position that prevents access to the at least one output connector opening.

35. A waveguide module assembly for receiving optical connectors, the waveguide module assembly comprising:
a first shell housing comprising a first cavity portion;
a second shell housing coupled to the first shell housing, wherein the second shell housing comprises a second cavity portion, and the first cavity portion and the second cavity portion define a cavity when the first shell housing is mated to the second shell housing
a waveguide substrate comprising at least one waveguide, a first surface, and a second surface opposite the first surface, wherein the waveguide substrate is at least partially disposed within the cavity when the first shell housing is positioned over the first surface of the waveguide substrate and the second shell housing is positioned over the second surface of the waveguide substrate.

36. The waveguide module assembly of claim 35, wherein the first shell housing and the second shell housing define at least one input connector opening for receiving an input connector, and the first shell housing and the second shell housing define at least one output connector opening for receiving an output connector.

37. The waveguide module assembly of claim 36, wherein:
the at least one waveguide comprises a plurality of waveguides;
the at least one output connector opening comprises a plurality of output connector openings;
the at least one input connector opening comprises one input connector opening; and
the plurality of waveguides branches from an input edge of the waveguide substrate at the one input connector opening to an output edge of the waveguide substrate at the plurality of output connector openings.

38. The waveguide module assembly of claim 36, wherein an interior surface at the at least one output connector opening comprises a notch for receiving a detent feature of the output connector.

39. The waveguide module assembly of claim 36, wherein:
the first shell housing comprises at least one first input connector recess and at least one first output connector recess;
the second shell housing comprises at least one second input connector recess and at least one second output connector recess;
the at least one first input connector recess and the at least one second input connector recess define the at least one input connector opening; and
the at least one first output connector recess and the at least one second output connector recess define the at least one output connector opening.

40. A waveguide module assembly for receiving optical connectors, the waveguide module assembly comprising:
a first shell housing comprising a first cavity slot;
a second shell housing coupled to the first shell housing, wherein the second shell housing comprises a second cavity slot and the first cavity slot and the second cavity slot define a cavity; and
a waveguide substrate comprising at least one waveguide, a first surface, and a second surface opposite the first surface, wherein the waveguide substrate is at least partially disposed within the cavity.

41. The waveguide module assembly of claim 40, wherein the first shell housing has a first engagement feature at an end and the second shell housing has a second engagement feature at a second end that mates with the first engagement feature.

42. The waveguide module assembly of claim 41, wherein the first engagement feature comprises one or more latching arms and the second engagement feature comprises one or more grooves.

43. The waveguide module assembly of claim 41, wherein the first engagement feature comprises one or more prongs having an angled surface, and the second engagement feature comprises one or more tapered walls operable to receive the one or more prongs.

44. A method of assembling a waveguide module assembly, the method comprising positioning a waveguide substrate into a cavity defined by a first shell housing coupled to a second shell housing, wherein:
the waveguide substrate comprises at least one waveguide, a first surface and a second surface; and
the waveguide substrate is at least partially disposed within the cavity such that at least a portion of the first surface and at least a portion of the second surface are covered by at least one of the first shell housing and the second shell housing.

45. The method of claim 44, wherein positioning the waveguide substrate into the cavity comprises:
positioning the waveguide substrate into a first cavity portion of the first shell housing such that the first shell housing at least partially covers the first surface of the waveguide substrate; and
coupling the second shell housing to the first shell housing such that the second shell housing at least partially covers the second surface of the waveguide substrate.

46. The method of claim 44, wherein positioning the waveguide substrate into the cavity comprises:
positioning the waveguide substrate into a first cavity slot of the first shell housing such that the first shell housing at least partially covers a portion of the first surface of the waveguide substrate and a second surface of the waveguide substrate; and
positioning the waveguide substrate into a second cavity slot of the second shell housing such that an end of the first shell housing engages an end of the second shell housing and the first cavity slot and the second cavity slot define the cavity.

47. The method of claim 44, further comprising applying a low modulus material between at least one of the first surface of the waveguide substrate and the first shell housing and between at least one of the second surface of the waveguide substrate and the second shell housing.

48. The method of claim 44, wherein:
the first shell housing and the second shell housing define an input connector opening for receiving an input connector, and the first shell housing and the second shell housing define a plurality of output connector openings for receiving a plurality of output connectors;
the at least one waveguide comprises a plurality of waveguides; and
the waveguide substrate is positioned within the cavity such that the plurality of waveguides branches from an input edge of the waveguide substrate at the input connector opening to an output edge of the waveguide substrate at the plurality of output connector openings.

49. The method of claim 48, further comprising:
applying an input cover to an input edge of the first shell housing and the second shell housing such that the input cover is translatable between an open position allowing access to the input connector opening and a closed position that prevents access to the input connector opening; and
applying an output cover to an output edge of the first shell housing and the second shell housing such that the output cover is translatable between an open position allowing access to the plurality of output connector openings and a closed position preventing access to the plurality of output connector openings.
